(19) United States
(12) Patent Application Publication
(10) Pub. No.: US 2025/0372676 A1
(43) Pub. Date: Dec. 4, 2025

(54) SOLID OXIDE FUEL CELL

(71) Applicant: ATSUMITEC CO., LTD., Hamamatsu-shi, Shizuoka (JP)

(72) Inventors: Kazuhiro UCHIYAMA, Sendai-shi (JP); Naoki UCHIYAMA, Hamamatsu-shi (JP); Seigou NAKABAYASHI, Hamamatsu-shi (JP); Yasuyuki UCHIYAMA, Hamamatsu-shi (JP)

(21) Appl. No.: 18/681,937

(22) PCT Filed: Aug. 9, 2022
(86) PCT No.: PCT/JP2022/030357

§ 371 Date: Feb. 3, 2025

(30) Foreign Application Priority Data
Aug. 10, 2021 (JP) 2021-130509

(51) Int. Cl. H01M 8/04223; H01M 8/04007; H01M 8/12; H01M 8/1286; H01M 8/242; H01M 8/2425; H01M 8/249

(52) U.S. Cl. CPC H01M 8/04268; H01M 8/04037; H01M 8/1286; H01M 8/242; H01M 8/249; H01M 2008/1293; H01M 8/2425

(57) ABSTRACT

A solid oxide fuel cell includes an electrode including an electrolyte ceramic, and an anode electrode and a cathode electrode sandwiching the electrolyte ceramic from both sides, a metal frame located around the electrode so as to sandwich the electrode from both sides and physically contact each of the anode electrode and the cathode electrode, and a power supply port electrically connected to the metal frame to supply electric power of a high frequency to the metal frame. A shape, a size, and a material of the electrode and the metal frame are selected so that a resonance frequency of the electrode becomes a target resonance frequency, and a transmission frequency from a high frequency oscillator is adjusted to be the target resonance frequency.

### BACKGROUND OF THE INVENTION

### 1. Field of the Invention

The present invention relates to a solid oxide fuel cell.

### 2. Description of the Related Art

A solid oxide fuel cell (SOFC) is a fuel cell in which a cell is formed by sandwiching an electrolyte ceramic between an anode layer and a cathode layer. The SOFC has a high operating temperature, and it is necessary to heat an internal structure (such as a cell) to near 700° C. in order to start power generation.

Conventionally, as a method of heating the SOFC, a heating method of heating an external structure (such as a housing) using a gas burner or the like is known. However, in the heating method using the gas burner, since the internal structure is indirectly warmed by using heat applied to the external structure, heating efficiency is low, and a long time and a large amount of energy are required until the internal structure reaches a target temperature (operating temperature). Further, in the heating method using the gas burner, emissions such (nitrogen oxides) are generated.

Therefore, conventionally, a method of heating a power generator (cell) of an SOFC by irradiating the power generator with microwaves has been proposed (for example, see Japanese Unexamined Patent Publication No. 2011-165516). According to this heating method using microwaves, the generation of emissions such as NOx (nitrogen oxides) is suppressed.

However, even with a conventional heating method using microwaves, sufficiently heating high efficiency cannot be achieved, and a long time and a large amount of energy are still required until the internal structure reaches the target temperature (operating temperature).

### SUMMARY OF THE INVENTION

Example embodiments of the present invention provide solid oxide fuel cells each having high heating efficiency and capable of raising the temperature of an internal structure to a target temperature (operating temperature) in a short time and with a small amount of energy.

An aspect of an example embodiment of the present invention is a solid oxide fuel cell, and the solid oxide fuel cell includes an electrode including an electrolyte ceramic, and an anode electrode and a cathode electrode sandwiching the electrolyte ceramic from both sides, a metal frame located around the electrode so as to sandwich the electrode from both sides, and to physically contact each of the anode electrode and the cathode electrode, and a power supply port electrically connected to the metal frame to supply electric power of a high frequency to the metal frame, and a shape, a size, and a material of the electrode and the metal frame are selected so that a resonance frequency of the electrode becomes a predetermined target resonance frequency, and a transmission frequency from a high frequency oscillator that generates the high frequency is adjusted to be the predetermined target resonance frequency.

As will be described below, there are other aspects of example embodiments of the present invention. Therefore, the disclosure of the present invention is intended to provide some aspects of example embodiments of the present invention and is not intended to limit the scope of the present invention as described and claimed herein.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an explanatory view illustrating a

configuration of a solid oxide fuel cell according to a first example embodiment of the present invention.

FIG. 2 is a perspective view of a main portion of the solid oxide fuel cell according to the first example embodiment of the present invention.

FIG. 3 is an explanatory view illustrating a configuration of a solid oxide fuel cell according to a second example embodiment of the present invention.

FIG. 4 is an explanatory view illustrating a configuration of a solid oxide fuel cell according to a third example embodiment of the present invention.

FIG. 5 is an explanatory view illustrating a configuration of a solid oxide fuel cell according to a fourth example embodiment of the present invention.

FIG. 6 is an explanatory view illustrating a configuration of a solid oxide fuel cell according to a fifth example embodiment of the present invention.

FIG. 7 is an explanatory view illustrating a configuration of a solid oxide fuel cell according to a sixth example embodiment of the present invention.

### DETAILED DESCRIPTION OF THE EXAMPLE EMBODIMENTS

Example embodiments of the present invention are

described in detail below. However, the following detailed description and accompanying drawings are not intended to limit the present invention.

A solid oxide fuel cell according to an example

embodiment of the present invention includes an electrode including an electrolyte ceramic, and an anode electrode and a cathode electrode sandwiching the electrolyte ceramic from both sides, a metal frame located around the electrode so as to sandwich the electrode from both sides, and physically contact each of the anode electrode and the cathode electrode, and a power supply port electrically connected to the metal frame to supply electric power of a high frequency to the metal frame, and a shape, a size, and a material of the electrode and the metal frame are selected so that a resonance frequency of the electrode becomes a predetermined target resonance frequency, and a transmission frequency from a high frequency oscillator that generates the high frequency is adjusted to be the predetermined target resonance frequency.

According to this configuration, when electric power is supplied from the power supply port to the metal frame disposed around the electrode, the high frequency is directly supplied to the electrode through the metal frame, and the electrode is heated by the supplied high frequency. In this case, since the internal structure is directly warmed by using the high frequency applied to the internal structure (electrode), the heating efficiency is high, and the temperature of the internal structure can be raised to the target temperature (operating temperature) in a short time with a small amount of energy.

In addition, since the transmission frequency from the high frequency oscillator and the resonance frequency of the electrode are configured to be the same (predetermined target resonance frequency), the high frequency supplied to the electrode resonates in the electrode, and the heating efficiency by the high frequency can be improved.

Further, in a solid oxide fuel cell according to an example embodiment of the present invention, the high frequency oscillator may include a transmission frequency adjuster that is configured or programmed to adjust a transmission frequency of the high frequency oscillated from the high frequency oscillator, and the transmission frequency adjuster may be configured or programmed to cause the transmission frequency of the high frequency oscillator to follow the resonance frequency of the electrode that changes in accordance with a temperature of the electrode.

According to this configuration, the oscillation frequency of the high frequency oscillator and the resonance frequency of the electrode can be matched even when the resonance frequency of the electrode changes in accordance with the temperature change of the electrode (e.g., the temperature may change from room temperature to near 700° C.). Therefore, it is possible to reduce or prevent a decrease in heating efficiency by the high frequency due to a temperature change of the electrode.

In a solid oxide fuel cell according to an example embodiment of the present invention, the electrode may include a plurality of electrodes with different resonance frequencies, and the high frequency oscillator may be configured to be capable of transmitting high frequencies at a plurality of different oscillation frequencies.

According to this configuration, the solid oxide fuel cell includes the plurality of electrodes with different resonance frequencies, and the high frequency oscillator can transmit high frequencies at the plurality of different oscillation frequencies. For example, when three electrodes (one outer side electrode A, a middle electrode B, and another outer side electrode C) with different resonance frequencies are provided, the three electrodes (the electrode A, the electrode B, and the electrode C) can be simultaneously and efficiently heated by simultaneously transmitting high frequencies of the three frequencies (f_{A}, f_{B}, and f_{c}) which are the same as the resonance frequencies of the three electrodes (the resonance frequency f_{A} of the electrode A, the resonance frequency IB of the electrode B, and the resonance frequency f_{c} of the electrode C) from the high frequency oscillator. Further, when only a certain electrode (the middle electrode B) among the three electrodes is desired to be heated, the target electrode (the middle electrode B) can be efficiently heated by supplying the high frequency at the resonance frequency of the electrode (the resonance frequency f_{B} of the electrode B).

In a solid oxide fuel cell according to an example embodiment of the present invention, the high frequency oscillator may include a frequency controller configured or programmed to individually control the plurality of different oscillation frequencies.

According to this configuration, the heating temperatures of the three electrodes (the electrode A, the electrode B, and the electrode C) can be individually controlled by individually controlling the electric power of high frequencies of the three frequencies (f_{A}, f_{B}, and f_{C})) to be transmitted to the power supply ports.

In a solid oxide fuel cell according to an example embodiment of the present invention, the high frequency oscillator that generates the high frequency may include an electric power controller configured or programmed to control electric power of a high frequency to be supplied to the power supply port in accordance with a temperature of the electrode.

According to this configuration, the electric power of the high frequency supplied to the power supply port is controlled in accordance with the temperature of the electrode. When the temperature of the electrode is increased, less electric power of the high frequency is required to be supplied to the power supply port (as compared with a case where the temperature of the electrode is low). Therefore, by lessening the electric power of the high frequency supplied to the power supply port as the temperature of the electrode increases, the electric power of the high frequency to be supplied can be reduced in total.

Further, in a solid oxide fuel cell according to an example embodiment of the present invention, the high frequency oscillator that generates the high frequency may include a pulse-driving controller configured or programmed to cause pulse-driving to be performed on a time axis.

According to this configuration, the high frequency oscillator is controlled to perform pulse-driving (under pulse-driving control) on the time axis. Even when the high frequency oscillator is subjected to pulse-driving control (for example, ON/OFF control), the temperature of the electrode can be sufficiently increased by setting the duty ratio of the ON/OFF control such that the temperature increase during the ON time exceeds the temperature decrease during the OFF time. During the ON control, the high frequency is supplied to the power supply port, while during the OFF control, the high frequency is not supplied to the power supply port. Therefore, the electric power of the high frequency to be supplied can be reduced in total. Further, even when the position of a cell to be heated is offset, the temperature of the cell is diffused during the OFF time, and the temperature of the cell can be made uniform. Further, since the continuous operation time of the high frequency oscillator is reduced, the life of the high frequency oscillator can be extended.

Further, a solid oxide fuel cell according to an example embodiment of the present invention may include a switch circuit to switch a supply destination of the electric power of the high frequency to be supplied to the power supply port from the high frequency oscillator to a power supply port of another solid oxide fuel cell, and a switch driving controller configured or programmed to switch the switch circuit.

According to this configuration, the supply destination of the high frequency supplied from the high frequency oscillator to the power supply port can be switched to the power supply port of another solid oxide fuel cell by controlling the switch circuit using the switch driving controller. This makes it possible to continuously supply high frequencies from one high frequency oscillator to the power supply ports of a plurality of solid oxide fuel cells on the time axis. For example, the duty ratio of the switch driving control may be varied in accordance with a temperature difference between the electrodes of the respective solid oxide fuel cells. The duty ratio of the switch driving control may also vary in accordance with the ratio of the physical sizes of the respective solid oxide fuel cells.

According to example embodiments of the present invention, the heating efficiency is high, and the temperature of the internal structure can be raised to the target temperature (operating temperature) in a short time with a small amount of energy.

Hereinafter, a solid oxide fuel cell according to an example embodiment of the present invention will be described with reference to the drawings. In this example embodiment, the case of a solid oxide fuel cell used for an electronic device, an electric vehicle, or the like will be described.

### First Example Embodiment

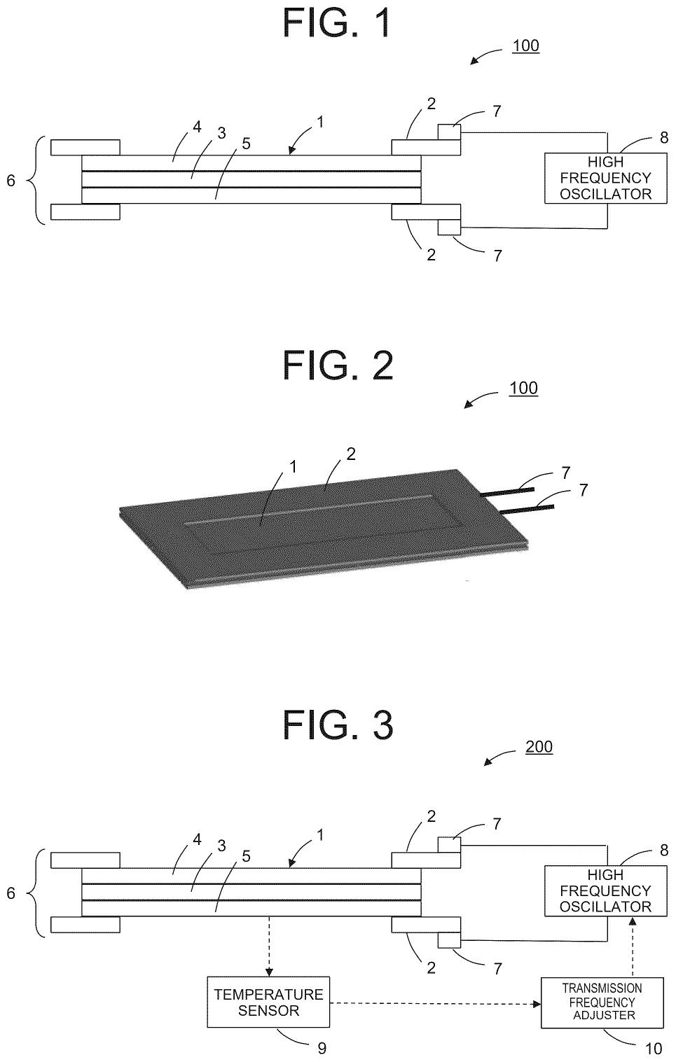

A configuration of a solid oxide fuel cell according to the first example embodiment of the present invention will be described with reference to the drawings. FIG. 1 is an explanatory view illustrating a configuration of a solid oxide fuel cell according to the present example embodiment, and FIG. 2 is a perspective view of a main portion of the solid oxide fuel cell according to the present example embodiment.

As illustrated in FIGS. 1 and 2, a solid oxide fuel cell 100 of the present example embodiment includes a plate-shaped electrode 1 and plate-shaped metal frames 2 disposed so as to sandwich the electrode 1 from both sides (both upper and lower sides in FIG. 1). The metal frames 2 each have an opening in the center (see FIG. 2). The electrode 1 includes a plate-shaped electrolyte ceramic 3 (dielectric), and an anode electrode 4 and a cathode electrode 5 that sandwich the electrolyte ceramic 3 from both sides (both upper and lower sides in FIG. 1). In other words, the electrode 1 and the metal frames 2 define a cell unit 6 (cell configuration).

The metal frames 2 are in physical contact with the anode electrode 4 and the cathode electrode 5. In the example of FIG. 1, a metal frame 2 on an upper side is in physical contact with the anode electrode 4, and a metal frame 2 on a lower side is in physical contact with the cathode electrode 5. A power supply port 7 is electrically connected to the metal frame 2. A high frequency oscillator 8 is electrically connected to the power supply port 7, and electric power of a high frequency (e.g., microwave) is supplied from the power supply port 7 to the metal frame 2.

In the solid oxide fuel cell 100 of the present example embodiment, the shape, size, and material of the electrode 1 and the metal frame 2 are selected so that a resonance frequency of the electrode 1 becomes a predetermined target resonance frequency. The transmission frequency from the high frequency oscillator 8 is adjusted so as to be the target resonance frequency. For example, the resonance frequency of the electrode 1 is the target resonance frequency of about 740 MHz in a case where the electrode 1 and the metal frame 2 each have a rectangular or substantially rectangular shape in a plan view (see FIG. 2), the size of the metal frame 2 is about 65 mm in length and about 41 mm in width, the size of the opening in the metal frame 2 is about 48 mm in length and about 18 mm in width, the size of the anode electrode 4 and cathode electrode 5 is about 50.4 mm in length, about 23.7 mm in width and about 0.18 mm in thickness, the size of the electrolyte ceramic 3 is about 49.6 mm in length, about 19.8 mm in width and about 0.2 mm in thickness, the material of electrode 1 is a material with an electrical conductivity of about 1.66×106 S/m, (for example, nickel oxide (NiO) or the like is used as the material of the anode electrode 4, and lanthanum strontium cobalt ferrite (LSCF), lanthanum strontium manganite (LSM) or the like is used as the material of the cathode electrode 5, the material of the metal frame 2 is a material with an electrical conductivity of about 1.66×106 S/m (for example, steel use stainless (SUS) or the like is used), and the material of the electrolyte ceramic 3 is a material with a dielectric constant of about 20.5 and a dielectric loss tangent of about 0.01 (for example, yttria stabilized zirconia (YSZ), gadolinium doped ceria (GDC) or the like is used).

According to the solid oxide fuel cell 100 of the first example embodiment of the present invention, when electric power is supplied from the power supply port 7 to the metal frame 2 disposed around the electrode 1, a high frequency is directly supplied to the electrode 1 through the metal frame 2, and the electrode 1 is heated by the supplied high frequency. In this case, since the internal structure is directly warmed by using the high frequency applied to the internal structure (electrode 1), the heating efficiency is high, and the temperature of the internal structure can be raised to the target temperature (operating temperature) in a short time and with a small amount of energy.

In addition, since the solid oxide fuel cell 100 of the present example embodiment is configured such that the transmission frequency from the high frequency oscillator 8 and the resonance frequency of the electrode 1 are the same (predetermined target resonance frequency), the high frequency supplied to the electrode 1 resonates at the electrode 1, and the heating efficiency by the high frequency can be improved.

### Second Example Embodiment

Next, a solid oxide fuel cell according to the second example embodiment of the present invention will be described. Here, differences between the solid oxide fuel cell of the second example embodiment and that of the first example embodiment will be mainly described. Unless otherwise specified, the configuration and operation of the present example embodiment are the same as those of the first example embodiment.

FIG. 3 is an explanatory view illustrating the configuration of the solid oxide fuel cell of the present example embodiment. As illustrated in FIG. 3, a solid oxide fuel cell 200 of the present example embodiment includes a temperature sensor 9 that measures the temperature of the electrode 1, and a transmission frequency adjuster 10 configured to adjust the transmission frequency of the high frequency oscillated from the high frequency oscillator 8. The transmission frequency adjuster 10 is configured to cause the transmission frequency of the high frequency oscillator 8 to follow the resonance frequency of the electrode that changes in accordance with the temperature of the electrode 1. For example, when the resonance frequency of the electrode 1 changes at a change rate of about −50 MHz/500 degrees in accordance with the temperatures of the electrode 1, the transmission frequency adjuster 10 performs control so as to change the transmission frequency of the high frequency oscillator 8 at a change rate of about −100 kHz/degree.

According to the solid oxide fuel cell 200 of the second example embodiment of the present invention, the same effects as those of the first example embodiment can be obtained.

In addition, in the present example embodiment, even when the resonance frequency of the electrode 1 changes in accordance with the temperature change of the electrode 1, the oscillation frequency of the high frequency oscillator 8 and the resonance frequency of the electrode 1 can be matched. For example, in a general SOFC, the temperature of the electrode 1 changes from room temperature to near 700° C., but even in the case where the resonance frequency of the electrode 1 changes in accordance with such a temperature change of the electrode 1, the oscillation frequency of the high frequency oscillator 8 and the resonance frequency of the electrode 1 can be matched. Therefore, it is possible to reduce or prevent a decrease in heating efficiency by high frequencies due to a temperature change of the electrode 1. Here, the case where the temperature of the electrode 1 changes from room temperature to near 700° C. has been described as an example, but the range of the temperature change of the electrode 1 is not limited thereto.

### Third Example Embodiment

Next, a solid oxide fuel cell according to the third

example embodiment of the present invention will be described. Here, differences between the solid oxide fuel cell of the third example embodiment and that of the first example embodiment will be mainly described. Unless otherwise specified, the configuration and operation of the present example embodiment are the same as those of the first example embodiment.

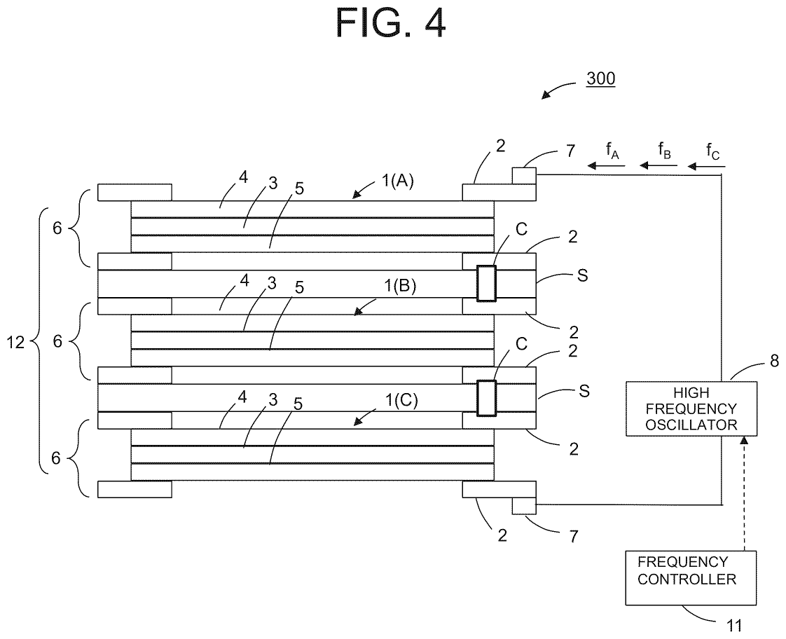

FIG. 4 is an explanatory view illustrating the configuration of the solid oxide fuel cell of the present example embodiment. As illustrated in FIG. 4, in a solid oxide fuel cell 300 of the present example embodiment, a plurality of cell units 6 are arranged in series and electrically connected to each other. A separator S for gas is disposed between the cell units 6. The separator S is made of, for example, mica. Even in the case where the separator S is provided between the cell unit 6 and the cell unit 6, the metal frame 2 of the cell unit 6 and the metal frame 2 of the cell unit 6 are electrically connected to each other via a connection portion C (see FIG. 4). For example, the same material (metal) as the metal frame 2 can be used as the material of the connection portion C.

It can also be said that in the solid oxide fuel cell 300 of the present example embodiment, the plurality of cell units 6 are stacked (layered) to define one stack unit 12 (stack configuration). The power supply port 7 is electrically connected to the metal frame 2 disposed on the outermost side (the uppermost side and the lowermost side in FIG. 4) among the metal frames 2 of the plurality of cell units 6, and the electric power of the high frequency is supplied from the power supply port 7 to the metal frame 2 disposed on the outermost side.

Further, the solid oxide fuel cell 300 of the present example embodiment includes a plurality of electrodes 1 (electrode

A, electrode B, and electrode C) with different resonance frequencies, and the high frequency oscillator 8 is configured to be capable of transmitting high frequencies at a plurality of different oscillation frequencies (f_{A}, f_{B}, and f_{C}). The high frequency oscillator 8 is provided with a frequency controller 11 configured or programmed to individually control a plurality of different oscillation frequencies (f_{A}, f_{B}, and f_{C}). In FIG. 4, three electrodes 1 are illustrated as an example of the plurality of electrodes 1 with different resonance frequencies, but the number of electrodes 1 is not limited thereto.

According to the solid oxide fuel cell 300 of the third example embodiment of the present invention, the same effects as those of the first example embodiment can be obtained.

In addition, the solid oxide fuel cell 300 of the present example embodiment includes a plurality of electrodes s 1 with different resonance frequencies, and the high frequency oscillator 8 can transmit high frequencies at a plurality of different oscillation frequencies. For example, when three electrodes (one outer side electrode A, a middle electrode B, and another outer side electrode C) with different resonance frequencies are provided, the three electrodes (the electrode A, the electrode B, and the electrode C) can be simultaneously and efficiently heated by simultaneously transmitting high frequencies of the three frequencies (f_{A}, f_{B}, and f_{C}) which are the same as the resonance frequencies of the three electrodes (the resonance frequency f_{A} of the electrode A, the resonance frequency f_{B} of the electrode B, and the resonance frequency f_{C} of the electrode C) from the high frequency oscillator. Further, when only a certain electrode (the middle electrode B) among the three electrodes is desired to be heated, the target electrode (the middle electrode B) can be efficiently heated by supplying the high frequency at the resonance frequency of the electrode (the resonance frequency f_{B} of the electrode B).

In this example embodiment, the heating temperatures of the three electrodes (the electrode A, the electrode B, and the electrode C) can be individually controlled by individually controlling the electric power of high frequencies of the three frequencies (f_{A}, f_{B}, and f_{C})) to be transmitted to the power supply ports.

### Fourth Example Embodiment

Next, a solid oxide fuel cell according to the fourth example embodiment of the present invention will be described. Here, differences between the solid oxide fuel cell of the fourth example embodiment and that of the third example embodiment will be mainly described. Unless otherwise specified, the configuration and operation of the present example embodiment are the same as those of the third example embodiment.

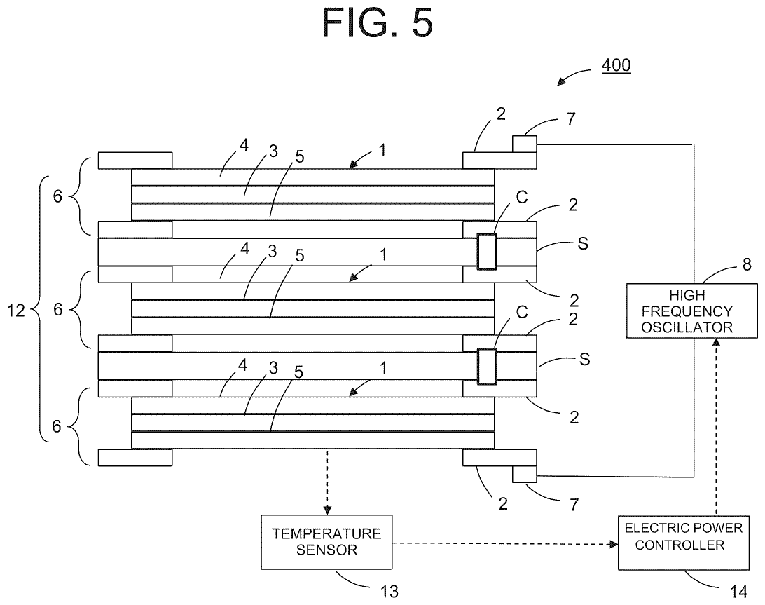

FIG. 5 is an explanatory view illustrating the configuration of the solid oxide fuel cell of the present example embodiment. As illustrated in FIG. 5, a solid oxide fuel cell 400 of the present example embodiment includes a temperature sensor 13 that measures the temperature of the electrode 1, and an electric power controller 14 that controls the electric power of the high frequency to be supplied to the power supply port 7 in accordance with the temperature of the electrode 1. For example, even when the electrode 1 is heated up to about 700° C., required electric power of a high frequency differs between a case of heating from room temperature (about 25° C.) and a case of heating from about 400° C. Therefore, the temperature of the electrode 1 is measured by the temperature sensor 13, and the output power of the high frequency oscillator 8 is controlled by the electric power controller 14 according to the measured temperature. For example, when the temperature of the electrode 1 is low, the output power of the high frequency oscillator 8 is increased, and when the temperature of the electrode 1 is high, the output power of the high frequency oscillator 8 is decreased.

According to the solid oxide fuel cell 400 of the fourth example embodiment of the present invention, the same effects as those of the first example embodiment can be obtained.

Moreover, in the present example embodiment, the electric power of the high frequency supplied to the power supply port 7 is controlled in accordance with the temperature of the electrode 1. When the temperature of the electrode 1 is increased, less electric power of the high frequency is required to be supplied to the power supply port 7 (as compared with a case where the temperature of the electrode 1 is low). Therefore, by lessening the electric power of the high frequency supplied to the power supply port 7 as the temperature of the electrode 1 increases, the electric power of the high frequency to be supplied can be reduced in total. As a result, the solid oxide fuel cell 400 can be started up efficiently and quickly with minimum required electric power.

Further, in this example embodiment, the plurality of electrodes 1 arranged in series are electrically connected to each other via the metal frame 2 and the connection portion C, and these electrodes 1 can be regarded as a series connection of capacitors in terms of an electric circuit. Therefore, by supplying electric power from the power supply port 7 to the metal frame 2 disposed on the outermost side, the electric power of the high frequency can be uniformly supplied to all the electrodes 1.

### Fifth Example Embodiment

Next, a solid oxide fuel cell according to the fifth example embodiment of the present invention will be described. Here, differences between the solid oxide fuel cell of the fifth example embodiment and that of the third example embodiment will be mainly described. Unless otherwise specified, the configuration and operation of the present example embodiment are the same as those of the third example embodiment.

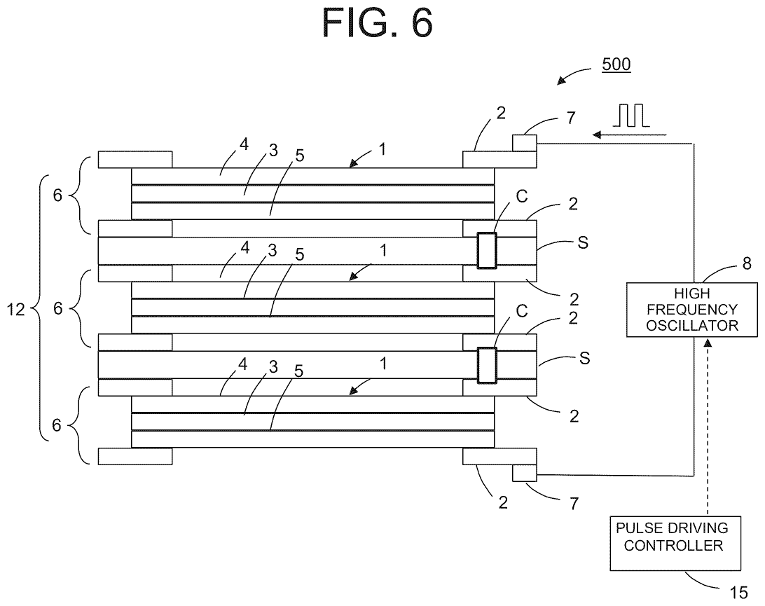

FIG. 6 is an explanatory view illustrating the configuration of the solid oxide fuel cell of the present example embodiment. As illustrated in FIG. 6, the solid oxide fuel cell 500 of the present example embodiment includes a pulse-driving controller 15 configured or programmed to cause the high frequency oscillator 8 to perform pulse-driving on a time axis. When the solid oxide fuel cell 500 is heated to a predetermined target temperature (for example, about 700° C.), the pulse-driving controller 15 controls ON/OFF of the high frequency oscillator 8 at a constant time cycle (for example, a cycle of about 60 seconds).

According to the solid oxide fuel cell 500 of the fifth example embodiment of the present invention, the same effects as those of the first example embodiment can be obtained.

In addition, in the present example embodiment, the high frequency oscillator 8 is controlled to perform pulse-driving (under pulse-driving control) on the time axis. Even when the high frequency oscillator 8 is subjected to pulse-driving control (for example, ON/OFF control), the temperature of the electrode 1 can be sufficiently increased by setting the duty ratio of the ON/OFF control such that the temperature increase during the ON time exceeds the temperature decrease during the OFF time. During the ON control, the high frequency is supplied to the power supply port 7, while during the OFF control, the high frequency is not supplied to the power supply port 7. Therefore, the electric power of the high frequency to be supplied can be reduced in total. Further, even when the position of a cell to be heated is offset, the temperature of the cell is diffused during the OFF time, and the temperature of the cell can be made uniform. Further, since the continuous operation time of the high frequency oscillator 8 is reduced, the life of the high frequency oscillator 8 can be extended.

### Sixth Example Embodiment

Next, a solid oxide fuel cell according to the sixth example embodiment of the present invention will be described. Here, the differences between the solid oxide fuel cell of the sixth example embodiment and that of the third example embodiment will be mainly described. Unless otherwise specified, the configuration and operation of the present example embodiment are the same as those of the third example embodiment.

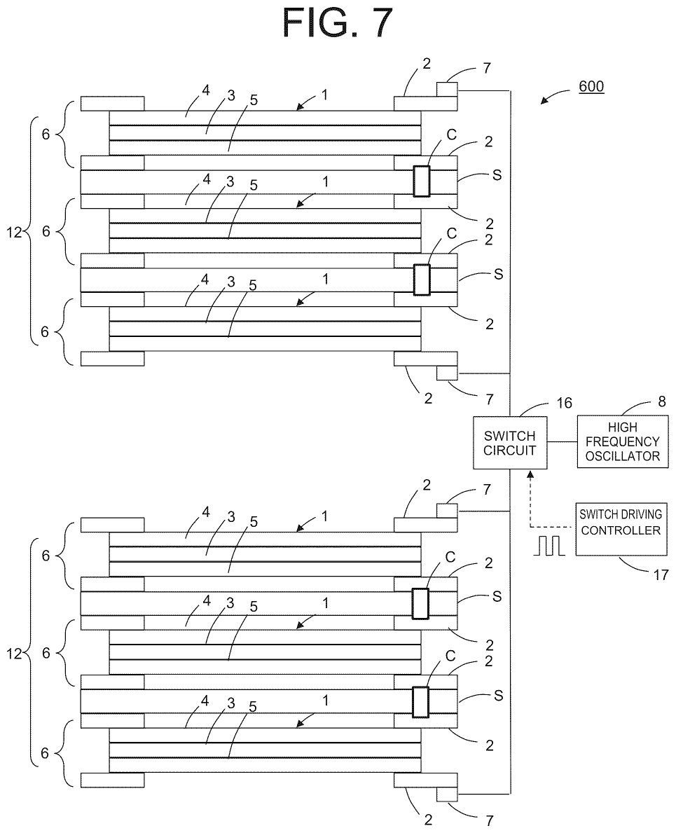

FIG. 7 is an explanatory view illustrating the configuration of the solid oxide fuel cell of the present example embodiment. As illustrated in FIG. 7, the solid oxide fuel cell 600 of the present example embodiment is provided with a plurality of (two in the example of FIG. 7) stack units 12 as the supply destination of the high frequency. The solid oxide fuel cell 600 of the present example embodiment includes a switch circuit 16 that switches the supply destination of the high frequency, and a switch driving controller 17 that switches the switch circuit 16.

The switch driving controller 17 is configured or programmed to control the switch circuit 16 so as to switch the supply destination of the high frequency at a constant time cycle (for example, a cycle of 60 seconds). For example, in the example of FIG. 7, the switch circuit 16 is controlled to supply electric power of a high frequency from the high frequency oscillator 8 to the power supply port 7 of one stack unit 12 (an upper stack unit 12 in FIG. 7) for a certain period of time (for example, about 60 seconds), and to supply electric power of a high frequency from the high frequency oscillator 8 to the power supply port 7 of another stack unit 12 (a lower stack unit 12 in FIG. 7) for the next certain period of time (for example, about 60 seconds).

According to the solid oxide fuel cell 600 of the sixth example embodiment of the present invention, the same effects as those of the first example embodiment can be obtained.

In addition, in the present example embodiment, the supply destination of the high frequency supplied from the high frequency oscillator 8 to the power supply port 7 is switched to the power supply port 7 of another solid oxide fuel cell (stack unit 12) by controlling the switch circuit 16 using the switch driving controller 17. As a result, it is possible to continuously supply the high frequency from one high frequency oscillator 8 to the power supply ports 7 of the plurality of solid oxide fuel cells (stack units 12) on the time axis. For example, the duty ratio of the switch driving control may be varied in accordance with a temperature difference between the electrodes 1 of the respective solid oxide fuel cells (stack units 12). The duty ratio of the switch driving control may also vary in accordance with the ratio of the physical sizes of the respective solid oxide fuel cells (stack units 12).

As described above, solid oxide fuel cells according to example embodiments of the present invention achieve the effects that the heating efficiency is high and the temperature of the internal structure can be raised to the target temperature (operating temperature) in a short time with a small amount of energy, and is useful for use in electronic devices, electric vehicles, or the like.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-7 (canceled)

8. A solid oxide fuel cell comprising:
an electrode including an electrolyte ceramic, and an anode electrode and a cathode electrode sandwiching the electrolyte ceramic from both sides;
a metal frame located around the electrode so as to sandwich the electrode from both sides, and physically contacts each of the anode electrode and the cathode electrode; and
a power supply port electrically connected to the metal frame to supply electric power of a high frequency to the metal frame; wherein
a shape, a size, and a material of the electrode and the metal frame are selected so that a resonance frequency of the electrode becomes a predetermined target resonance frequency; and
a transmission frequency from a high frequency oscillator that generates the high frequency is adjusted to be the predetermined target resonance frequency.

9. The solid oxide fuel cell according to claim 8, wherein
the high frequency oscillator includes a transmission frequency adjuster to adjust a transmission frequency of the high frequency oscillated from the high frequency oscillator; and
the transmission frequency adjuster is operable to cause the transmission frequency of the high frequency oscillator to follow the resonance frequency of the electrode that changes in accordance with a temperature of the electrode.

10. The solid oxide fuel cell according to claim 8, wherein
the electrode includes a plurality of electrodes with different resonance frequencies; and
the high frequency oscillator is capable of transmitting high frequencies at a plurality of different oscillation frequencies.

11. The solid oxide fuel cell according to claim 10, wherein the high frequency oscillator includes a frequency controller configured or programmed to individually control the plurality of different oscillation frequencies.

12. The solid oxide fuel cell according to claim 8, wherein a high frequency oscillator that generates the high frequency includes an electric power controller configured or programmed to control the electric power of the high frequency to be supplied to the power supply port in accordance with a temperature of the electrode.

13. The solid oxide fuel cell according to claim 8, wherein a high frequency oscillator that generates the high frequency includes a pulse-driving controller configured or programmed to cause pulse-driving to be performed on a time axis.

14. The solid oxide fuel cell according to claim 13, further comprising a switch circuit to switch a supply destination of the electric power of the high frequency to be supplied to the power supply port from the high frequency oscillator to a power supply port of another solid oxide fuel cell, and a switch driving controller configured or programmed to switch the switch circuit.
